(19) United States
(12) Patent Application Publication
(10) Pub. No.: US 2016/0340206 A1
(43) Pub. Date: Nov. 24, 2016

(54) SYSTEM AND METHOD OF PREDICTING WATER QUALITY IN A DECENTRALIZED TREATMENT SYSTEM

(71) Applicant: Shane Antos, Roswell, GA (US)

(72) Inventor: Shane Antos, Roswell, GA (US)

(21) Appl. No.: 15/158,549

(22) Filed: May 18, 2016

Related U.S. Application Data
(60) Provisional application No. 62/162,902, filed on May 18, 2015.

(51) Int. Cl. C02F 1/00

(52) U.S. Cl. CPC C02F 1/008; C02F 2209/06; C02F 2209/11; C02F 2209/36; C02F 2209/105

(57) ABSTRACT

Disclosed herein are systems and methods for reliably predicting water quality by characterizing the first water source with a first quality metric to provide a first measurement, treating the first water source with a first water treatment system to provide a first treated water supply, characterizing the first treated water supply with the first quality metric to provide a second measurement, determining differences, according to the first quality metric, between the first measurement and the second measurement, and determining an operating metric for the water treatment system based on the said differences.

### CROSS-REFERENCE TO RELATED APPLICATION

This application claims priority to U.S. Provisional Patent Application No. 62/162902, which was filed on May 18, 2015.

### BACKGROUND

The municipal provision of water supply for public use became widespread during the 20th century. As of 2005, 86% of US population rely on these public supplies according to USGS [http://pubs.er.usgs.gov/publication/cir1344].

Public supplies are regulated by Federal and State governments and are required to meet various quality standards. In the interest of public health, these standards establish maximum tolerated levels for a variety of chemical, physical, or biological contaminants.

The dominant model used to meet regulated quality standards relies on a centralized treatment process that sits between natural water source and distribution system that connects with end users. This design has two core problems that relate to quality and cost.

Because water must travel through distribution system after central treatment but prior to use, there is potential for contamination and quality thresholds may easily be violated.

Centralized treatment also requires the same treatment to be used for all water because it is blind to actual end use. For this reason, quality standards are calibrated for the most sensitive use—drinking water. However, drinking water accounts for less than 0.3% of total public water consumption. Uses that are much less sensitive to quality—leaks, lawn irrigation, toilet flushing—account for between 10× and 100× more consumption.

Measurement of contaminants and other quality parameters is generally carried out inside the centralized treatment location, making direct measurement an acceptable solution. As treatment architectures shift to decentralized locations, direct measurement becomes cumbersome and far less practical.

To the extent that decentralized treatment exists today, there is generally no centralized ownership/availability of quality data. One person may install a home treatment system; and a different person separately installs a home treatment system. To the extent that either party generates quality metrics, they are generally not exposed to each other. Therefor statistical methods, including machine learning, that exploit data patterns that occur across multiple instances—are not considered and not available.

More than $10 billion is spent each year on chemicals and energy for water treatment, and these have negative externalities for environment and, ironically, public health. The total cost of treatment is much higher still when labor and equipment are considered. Centralized treatment architecture is thus massively inefficient in economic terms.

Ongoing industrialization and population growth continue to contribute to both variety and prevalence of contaminants in natural water supplies. A vast and growing body of medical research continues to establish links between water contamination and epidemic levels of cancer, developmental problems, and other serious disease.

Technology and other advances in water treatment have certainly taken place as well, however many effective options for drinking water are simply not viable at the scale of total public water.

The preceding discussion suggests that designs for decentralized water treatment systems—where treatment occurs after distribution and prior to use—ought to be considered. Such designs enable treatment specific to each use and is not vulnerable to recontamination.

Since public water systems are required to monitor and verify compliance with regulatory standards, quality monitoring presents a core challenge for decentralized treatment architectures. Advances in analytical instrumentation and methods have improved the sensitivity, accuracy, and cost efficacy of water quality measurement. However, the cost and complexity of reliable measurement remains challenging for many contaminants of interest.

A need therefore exists for reliable water quality monitoring in a decentralized treatment architecture.

A need exists for predicting quality attributes in cases where direct measurement is not available.

### BRIEF DESCRIPTION OF THE SEVERAL VIEWS OF THE DRAWINGS

The following figures provide some illustrative examples of specific embodiments of the disclosed systems and methods. These figures should not be considered limiting to the scope of this disclosure in any way.

To easily identify the discussion of any particular element or act, the most significant digit or digits in a reference number refer to the figure number in which that element is first introduced.

FIG. 1 is a system diagram of an embodiment of a water quality control system.

FIG. 2 is an action flow diagram of an embodiment of a water quality control process.

FIG. 3 is an action flow diagram of an embodiment of a water quality control process.

FIG. 4 is a flow chart of an embodiment of a water quality control process.

FIG. 5 is a flow chart of an embodiment of a water quality control process.

FIG. 6 is a flow chart of an embodiment of a water quality control process.

FIG. 7 illustrates example components of a prediction node (702), treatment node (704), and analysis node (706).

FIG. 8 illustrates additional example components of a prediction node.

FIG. 9 is a system diagram displaying interactions between a central procession and data control cluster and various configurations of a water quality control system.

FIG. 10 is a system diagram of a water quality control system configured for pre quality, treatment, and post quality processes.

FIG. 11 is a system diagram of a water quality control system configured for a treatment only process.

FIG. 12 is a system diagram of a water quality controls system configured for a pre quality only process.

FIG. 13 is a system diagram illustrating one component of an exemplary method of predicting water quality.

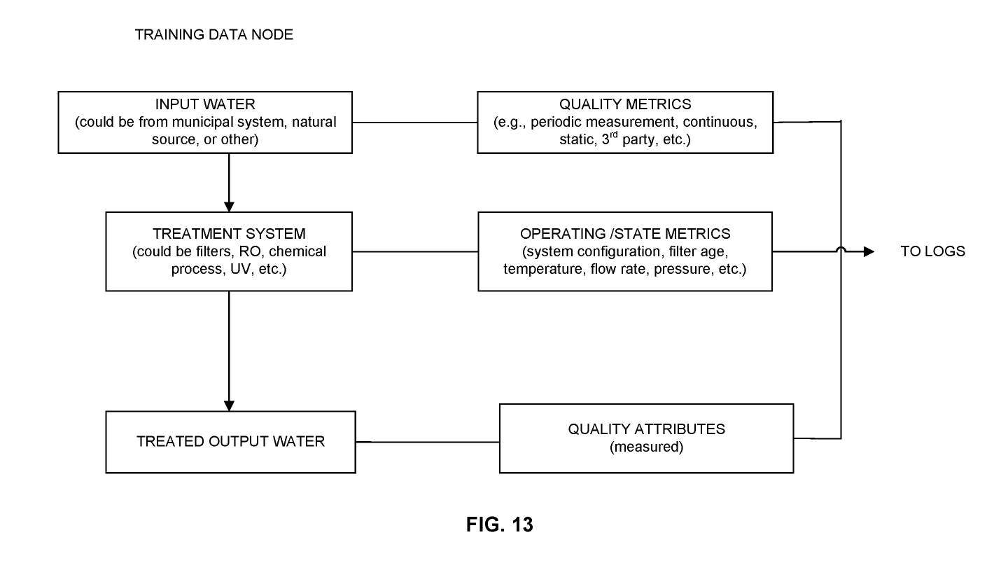

FIG. 14 is a system diagram illustrating one component of an exemplary method of predicting water quality.

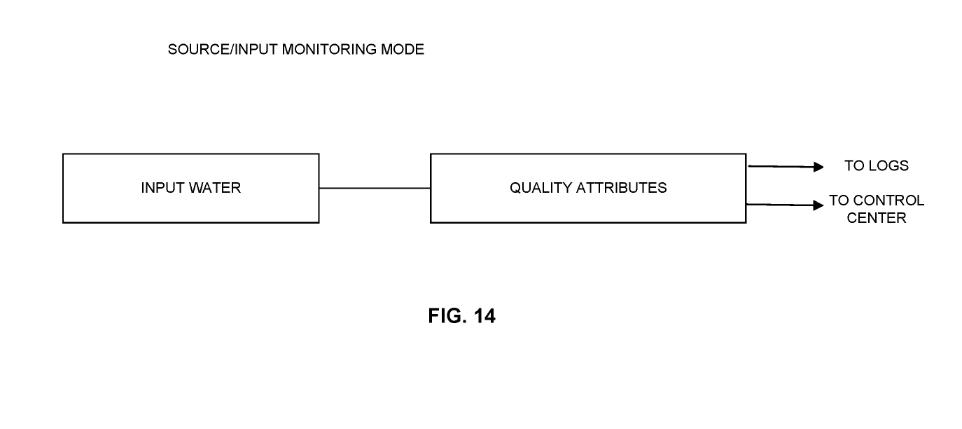

FIG. 15 is a system diagram illustrating one component of an exemplary method of predicting water quality.

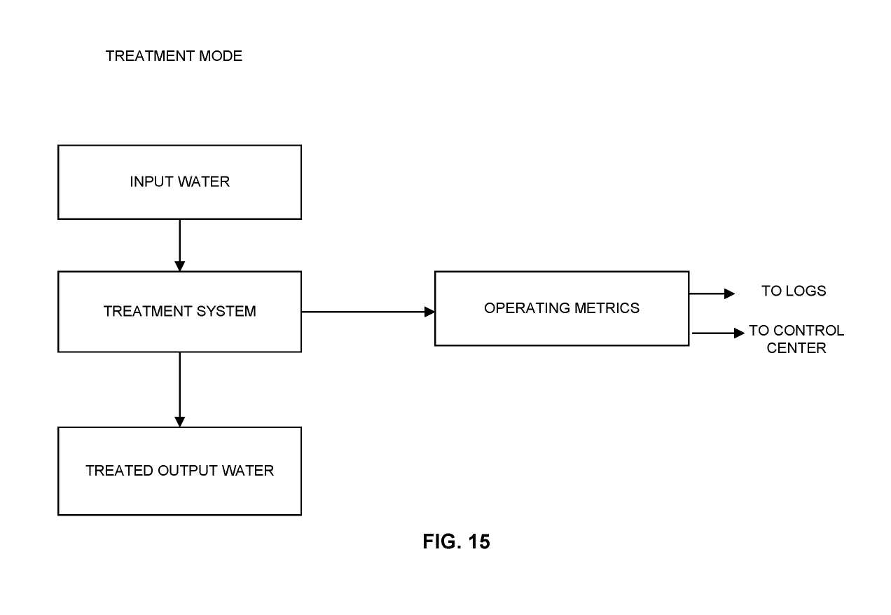

FIG. 16 is a system diagram illustrating one component of an exemplary method of predicting water quality.

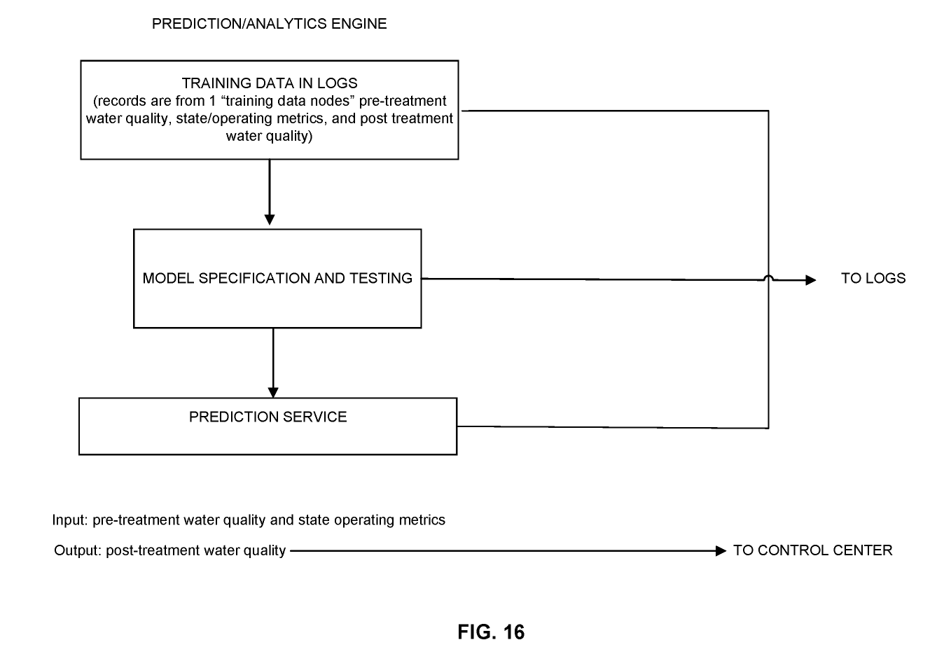

FIG. 17 is a system diagram illustrating one of an exemplary method of predicting water quality.

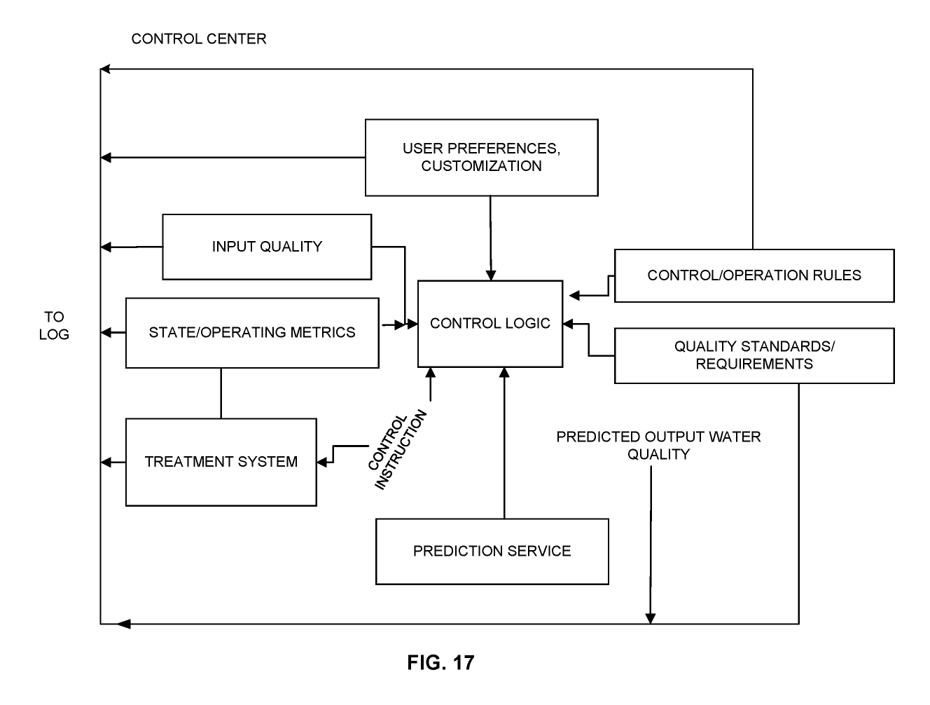

### DETAILED DESCRIPTION

Disclosed herein is a method of predicting and achieving water quality comprising a collection of distributed (aka decentralized) water treatment systems, a group of sensors throughout a water transmission system, and/or static data.

In some embodiments, data from the collection of distributed water treatment systems, the group of sensors and the static data are combined to predict water quality at specific locations within the water transmission system with a high rate of confidence.

In some embodiments, water transmission system maintenance is determined based on predicted water quality at specific locations within the water transmission system.

In some embodiments, a need for manual water testing is determined by predicted water quality at specific locations within the water transmission system.

In some embodiments, the group of sensors gather information intermittently.

In some embodiments, the group of sensors gather information continuously.

In some embodiments, the group of sensors gather information on water temperature, flow rate, turbidity, contamination, chemical composition, pressure, or particulate levels.

In some embodiments, the data from the collection of distributed water treatment systems, the group of sensors, and the static data are analyzed using machine learning.

In some embodiments, the group of sensors determine the time and amount of usage of a water resource.

In some embodiments, the disclosed method of predicting water quality includes sanitizing water with a water treatment system, distributing sanitized water via a water transmission system, cleansing water with a water filter, characterizing water with a water sensor, and/or predicting water quality at a specific location within the water transmission system.

In some embodiments, the disclosed method includes characterizing water within the water treatment system and/or characterizing water at one or more points within the water transmission system.

In some embodiments, the disclosed method includes predicting water quality using data collected by characterizing water within the water treatment system.

In some embodiments, the method includes predicting water quality using data collected by characterizing water within the water transmission system.

In some embodiments, the method includes predicting water quality using data collected by characterizing water within the water treatment system and/or predicting water quality using data collected by characterizing water within the water transmission system.

In some embodiments, the method includes predicting water quality using static data.

In some embodiments, the method includes maintaining the water transmission system by determining predicted water quality at specific locations within the water transmission system.

In some embodiments of the disclosed systems and methods, a need for manual water testing is determined by predicted water quality at specific locations within the water transmission system.

In some embodiments, the method includes a group of sensors. In some embodiments, the group of sensors gather information intermittently. In some embodiments, the group of sensors gather information continuously. In some embodiments, the group of sensors collect data from two or more water treatment systems.

In some embodiments, a sensor gathers physical data chosen from water temperature, water flow rate, water turbidity, water contamination, chemical composition, water pressure or water particulate levels.

In some embodiments, analyzing the data from two or more water treatment systems comprises using machine learning.

In some embodiments, the systems and methods disclosed herein include analyzing static data.

In some embodiments, a group of sensors determine the time and amount of usage of a water resource.

Disclosed herein are systems for predicting water quality, which include a collection of distributed water treatment systems, at least one sensor in a water transmission system, a database, a customer profile, and/or a machine-learning unit.

In some embodiments, the database may include a regulatory profile.

In some embodiments of the disclosed systems for predicting water quality, the machine-learning unit includes one or more processors that may be configured to generate predictions as to water quality at specific points in the water transmission system using information from the collection of distributed water treatment systems, the at least one sensor, and the database includes a regulatory profile and the customer profile.

In some embodiments of the disclosed systems for predicting water quality, at least one sensor in the water transmission system includes a group of sensors.

In some embodiments of the disclosed systems for predicting water quality, the customer profile includes customer location, rate of usage and time of usage.

In some embodiments of the disclosed systems for predicting water quality, the database includes a regulatory profile.

In some embodiments of the disclosed systems for predicting water quality, the database includes parameters for acceptable water quality.

Disclosed herein is a method of predicting water quality comprising:
A first water source;
Characterizing the first water source with a first quality metric to provide a first measurement;
Treating the first water source with a first water treatment system to provide a first treated water supply;
Characterizing the first treated water supply with the first quality metric to provide a second measurement;
Determining differences, according to the first quality metric, between the first measurement and the second measurement;
Determining an operating metric for the water treatment system based on the said differences.

As used herein, the term “characterizing” means quantifiably or qualitatively measuring an attribute. In one example, characterizing a water source includes measuring a particular quality metric by known analytical methods.

In one embodiment of the disclosed method, a volume of water is characterized to determine one or more quantifiable attributes. In one embodiment, the same volume of water is thereafter subjected to a reproducible treatment means. In one embodiment, the same volume of water is characterized again to determine the one or more quantifiable attributes after the water is subjected to the reproducible treatment means. In one embodiment a collection of characterization data from pre-treatment is juxtaposed with a collection of characterization data from post-treatment in order to determine how the particular treatment means affects water having certain quantifiable attributes.

In one embodiment, the disclosed method comprises a first quality metric is chosen from pH, turbidity, or chemical concentration.

In one embodiment, the disclosed method comprises a first quality metric chosen from a chemical concentration. In one embodiment, the chemical is an oxidizing agent. In one embodiment, the chemical is a metal.

In one embodiment, the disclosed method comprises an operating metric chosen from temperature, flow rate, pressure, time of usage, or volume of usage.

In one embodiment, the disclosed method comprises a water treatment system which is a filter. In one embodiment, the filter is a carbon filter. In another embodiment, the filter is a mechanical filter, such as a density separation tank or centrifuge. In another embodiment, the water treatment system is a chemical treatment system. In another embodiment, the water treatment system is a UV light system. In another embodiment, the water treatment system is an ion exchange system.

In one embodiment, the disclosed method comprises an operating metric which is flow rate.

In one embodiment, the disclosed method comprises a second water source; and characterizing the second water source with the first quality metric.

In one embodiment, the disclosed method comprises treating the second water source to provide a second treated water supply; characterizing the second treated water supply a plurality of times with the first quality metric to provide a plurality of measurements for the first quality metric; and collecting the said plurality of measurements in a data storage means, said data storage means equipped with a user interface capable of providing a physical representation of the measurements.

In one embodiment, the disclosed method comprises a third water source; and determining a value for the first quality metric for the third water source based on the plurality of measurements and the operating metric.

Disclosed herein is system for predicting water quality comprising:
A means for determining how a water treatment system affects a first water quality measurement for a first water source under a set of operating parameters;
A means for determining a second water quality measurement for a second water source at a time before processing by the said water treatment system;
A physical representation of the expected value of the first water quality measurement for the said second water source after processing by said water treatment system.

In one embodiment, the disclosed system additionally comprises an optimization engine for refining one or more operating parameters for processing the second water source with the water treatment system.

In one embodiment, the one or more operating parameters comprise flow rate.

As used herein, the term “determining how a water treatment system affects a first water quality measurement for a first water source under a set of operating parameters” includes any reliable method of analyzing the physical (e.g., chemical) composition of water before and after treatment so that the before and after measurements can be compared to draw conclusions about how the treatment system changed the composition of the water for a particular quality metric. In another embodiment, “determining how a water treatment system affects a first water quality measurement for a first water source under a set of operating parameters” means determining operating conditions that correspond to a particular change in the quality measurement.

As used herein the term “physical representation of the expected value” includes any concrete and tangible display or representation of the “expected value” determined by the disclosed systems. One example of such a physical representation is an electronic display, such as a computer screen. However, virtually any physical representation is within the scope of this disclosure.

As used herein, the term “means for determining a second water quality measurement” includes any reliable method of analyzing the physical (e.g., chemical) composition of water before and after treatment so that the before and after measurements can be compared to draw conclusions about how the treatment system changed the composition of the water for a particular quality metric.

As used herein, the term “data storage” in this context refers to a repository for operating and/or quality data from treatment systems and quality measurement systems. Data storage may also contain data relevant to quality and operating performance/environment from independent sources.

As used herein, the term “database” in this context refers to an organized collection of data (states of matter representing values, symbols, or control signals to device logic), structured typically into tables that comprise ‘rows’ and ‘columns’, although this structure is not implemented in every case. One column of a table is often designated a ‘key’ for purposes of creating indexes to rapidly search the database.

As used herein, the term “mobile device” in this context refers to any device that includes logic to communicate over a machine network and having a form factor compatible with being carried conveniently by a single human operator. Mobile devices typically have wireless communications capability via WAPs or cellular networks.

As used herein, the term “processor” in this context refers to any circuit or virtual circuit (a physical circuit emulated by logic executing on an actual processor) that manipulates data values according to control signals (e.g., ‘commands’, ‘op codes’, ‘machine code’, etc.) and which produces corresponding output signals that are applied to operate a machine.

As used herein, the term “sensor” in this context refers to a device or composition of matter that responds to a physical stimulus (as heat, light, sound, pressure, magnetism, chemical, or a particular motion) and transmits a resulting impulse (as for measurement or operating a control).

As used herein, the term “water treatment system” in this context refers to a system for changing the quality of water. In one example, a water treatment system changes the water to meet the water quality criteria for its fitness for the intended use. Systems may be distributed with respect to time, geography, or other logical dimensions or combinations thereof.

Provided herein is a collection of distributed water treatment systems and an associated operating platform to control system processes and to record operational data from or relating to the systems. Also provided herein is a quality measurement platform to record data relating to the composition and characteristics of water samples. Also provided herein is a statistical modeling and computation engine used for applications that include monitoring, reporting, machine learning models, predictive models or other analytics, as well as any other useful application or interface.

Disclosed herein is a system for predicting water quality comprising a collection of distributed water treatment systems, at least one sensor in a water transmission system, a database, a customer profile, and/or a machine-learning unit.

In some embodiments of the disclosed systems and methods, the database comprises a regulatory profile.

In some embodiments of the disclosed systems and methods, the machine-learning unit comprises one or more processors configured to generate predictions as to water quality at specific points in the water transmission system using information from the collection of distributed water treatment systems.

In some embodiments, the at least one sensor, and the database comprise a regulatory profile and the customer profile.

In some embodiments, the at least one sensor in the water transmission system comprises a group of sensors.

In some embodiments, the customer profile comprises customer location, rate of usage and time of usage.

In some embodiments, the database comprises a regulatory profile.

In some embodiments, the database comprises parameters for acceptable water quality.

Systems in the collection disclosed herein may be distributed with respect to time, geography, or other logical dimensions, as well as any combination of dimensions. For example, a collection could refer to the same system at two different periods of time, or systems in two locations at the same period of time, or systems in two locations that also exist in two distinct time periods.

In some embodiments, the architecture of a treatment system includes a water process component, a process control component, an operating metric component, and a data interface component. As used herein, the term “component” includes multiple functionally related devices and subsystems.

In some embodiments, the water process component includes one or more stages of water treatment to affect chemical, physical, biological, or other properties in various ways. In some embodiments, the water process component includes the means of receiving water from a source, delivering treated water to a destination, and transporting water between each stage of treatment when multiple stages are used.

The operating metric component includes devices, tools, processes, or other capabilities to understand and record conditions and activity related to the processing component and its surrounding environment. In some embodiments, the devices, tools, processes, or other capabilities include electronic sensors or other instruments in an online arrangement. In some embodiments, the arrangement is configured to provide automated, continuous measurement.

In some embodiments conditions and activity related to the processing component and its surrounding environment are measured manually. For example, in some embodiments, manual measurements are taken onsite.

Whether automated, continuous measurement or manual measurement, the data can be formatted as text, numeric, image, sound or other means of storing information for later interpretation and use.

The sensors, instruments, or other measurement devices may record one or more useful metrics including, but not limited to, temperature, flow rate, pressure, time of usage, volume of usage, or any other type of measurement generally desired.

The data interface component includes one or more device, tool, process, or other mechanism used to collect data from an operating metric component and transfer data to external storage and/or any other application that makes use of this data.

In one embodiment, transferring data takes place over wired or wireless data interfaces including Ethernet, Wi-Fi, cellular, Bluetooth, etc. In one embodiment, transferring data includes transmission of sound or light energy via interfaces suitable for sending and receiving such energy, for example radio, infrared, etc. In some embodiments, transferring data includes the exchange of conventional text data, such as via pen and paper, or any other reasonable method.

In one embodiment, the quality measurement system disclosed herein includes a measurement component and a data interface component.

In one embodiment, the measurement component includes one or more device, tool, process, or other means to understand and record one or more quality attributes (e.g., water quality metrics) associated with a given sample of water. In one embodiment, the quality attribute includes any physical, chemical, biological, or radiological, or other useful measure to indicate the suitability of the water for some application.

In one embodiment, the measurement component includes electronic, electrochemical, and/or mechanical sensors, or other sensors and instruments configured in an online arrangement that provides automated, continuous measurement. In one embodiment, the measurement component includes manual measurements taken onsite or performed remotely in a lab using spectrophotometry, chromatography, amperometry, or other equipment to analyze samples collected onsite. In one embodiment, the component includes independently reported information. For example, in one embodiment, the component includes an annual water quality report from a municipality.

The sensors, instruments, or other measurement devices may record one or more useful quality metrics including, but not limited to, pH, turbidity, presence or level of various contaminants, other chemical properties, or any other type of measurement generally desired.

In one embodiment, the data interface component includes one or more device, tool, process, or other mechanism used to collect data from quality measurement component and transfer data to external storage and/or any other application that makes use of this data. In one embodiment, the transfer takes place over wired or wireless data interfaces including Ethernet, Wi-Fi, cellular, Bluetooth, etc. In one embodiment, the transfer takes place via sound or light interfaces including infrared, etc. In one embodiment, the transfer occurs via pen and paper, or any other reasonable method.

In one embodiment, the Quality measurement systems are integrated with the treatment systems. In one embodiment of the integrated setup, the quality measurement system provides information about the nature and effectiveness of treatment by comparing untreated vs treated samples. In one embodiment, this treatment quality/performance information is further linked to the treatment system's operating data. In this manner it is possible to describe treatment outcomes in terms of the operating conditions that are required or co-occurring.

In one embodiment, the Quality measurement systems are independent of treatment systems.

In one embodiment, the modeling and computation engine includes one or more device, tool, process, or other mechanism to identify and describe any useful pattern of data. An exemplary modeling and computation engine includes three components: data storage, computation (aka “computational component”), and user interface.

In one embodiment, the data storage is a database or other means for storing information in analog or digital format. In one embodiment, the data storage acquires operating and/or quality data via respective interfaces of treatment systems and quality measurement systems. In one embodiment, the data storage includes data relevant to quality and operating performance/environment from independent sources.

In one embodiment, the computation component provides basic data functions, for example, cleaning, normalization, calculating aggregates or other derived metrics, and visual presentation. In one embodiment, the computational component involves statistical models that describe relationships among the data. In one embodiment, these models are chosen from time series forecasting, regression, cluster analysis, as well as machine learning approaches including decision tree, bayesian, neural network and other methods of machine learning, or predictive analytics.

As used herein, the term machine learning refers to a category of techniques where historical observation data are used to algorithmically construct a logical and/or quantitative model to describe relationships among various subsets or components. Within the context of this disclosure, the logical and/or quantitative model includes either or both of traditional statistical methods, where a model is specified a priori, and data are used to fit the model and generate parameters. Both types of approach may be used to predict values of missing data components based on values of the components that are present.

In cases where there may be complex relationships among data that are non-intuitive, machine learning methods are used to enable highly accurate and repeatable models that describe and predict patterns across quality and operating data.

In one embodiment of the disclosed systems and methods, computation is performed on one or more computers connected to storage component.

In one embodiment of the disclosed systems and methods, the user interface allows model discovery, specification, and testing. In one embodiment, the model is ‘trained’ on historical data using a given algorithmic approach. In one embodiment, the trained model is performance evaluated based on accuracy of predictions for various metrics based on independent data where the relevant values are known.

Input used within the disclosed systems and methods can be theoretical/modeled, real production data, or some combination thereof. In one embodiment, new models are evaluated and existing models are updated with new training data, thereby improving the prediction system continuously over time.

In one embodiment, the user interface (“UI”) functionality includes tasks such as reporting, monitoring, alarms, etc.

In one embodiment, the UI component is implemented via client-server architecture where client is web browser or mobile device.

In one embodiment, at least one UI device is attached to distributed treatment systems. Examples of a UI device in this context include a simple LED, for example, to indicate maintenance required, or an interactive touch screen display.

In one embodiment, a source quality model uses the most recent known value for a given location. In one embodiment, a source quality model uses the most recent known value from a location near the said given location. In one embodiment, the source quality model includes a seasonal adjustment. In one embodiment, the seasonal adjustment is estimated from historical patterns.

In some cases, one or more quality attributes are known but one or more other attributes are unknown. In some embodiments applying to such cases, the model includes known attributes as inputs.

For example, the expected level of lead in water is determined where pH is known based on historical data from similar locations, temporal patterns, and the observed relationship between pH and lead.

In the systems and methods disclosed herein, information about water quality may be explicitly specified using traditional statistical methods or algorithmically derived using machine learning methods.

One benefit of the systems and methods disclosed herein is predicting finished water quality. This benefit is important because finished water quality is what affects the end user or the end user's application.

In the systems and methods disclosed herein, finished water quality is predicted by using any combination of:

(a) known or predicted values for source water quality metrics;

(b) known or predicted attributes of treatment system itself;

(c) known or predicted values for treatment system operating metrics;

(d) known or predicted values for different finished quality metrics;

In one embodiment of the systems and methods disclosed herein, the level of trihalomethanes [THM] is predicted.

Within the context of this disclosure the term “THM” refers to a collection of volatile compounds that result from chlorine disinfection. THM are known carcinogens and thought to be representative of a larger set of harmful contaminants known as disinfection byproducts. THM are challenging to measure because they are volatile, generally occur at trace levels, and require advanced analytical instruments. THM levels are regulated and generally of significant interest, so a monitoring system that is accurate without the complexity of direct measurement is desirable.

In one embodiment of the systems and methods disclosed herein, THM levels are predicted with a statistical model based on explicit theoretical framework. In one embodiment, the said framework integrates the following logic:

THM occur when organic material in water reacts with chlorine;

organic material is more prevalent in surface water supplies vs groundwater;

organic material is more prevalent in warmer temperatures;

carbon treatment media can remove THM from water;

the effectiveness of carbon is affected by cumulative use; and

the effectiveness of carbon is affected by volume and surface area of carbon relative to flow rate of water.

Accordingly, in this example, the disclosed systems and methods would apply the following logic:

THM<source>=f(chlorine<source>, source type, time, location); and

THM<finished>=f(THM<source>, volume<carbon>, surfacearea<carbon>, cumulativevolume<treatment>, flowrate<treatment>)

In one embodiment, the model uses traditional statistics to specify a relationship among variables and then fit parameters to historical data. In one embodiment, machine learning approaches algorithmically determine complex interactions and patterns in the data.

### DRAWINGS

The following drawings are illustrative examples of particular embodiments of this disclosure and should not be read as limiting in any way.

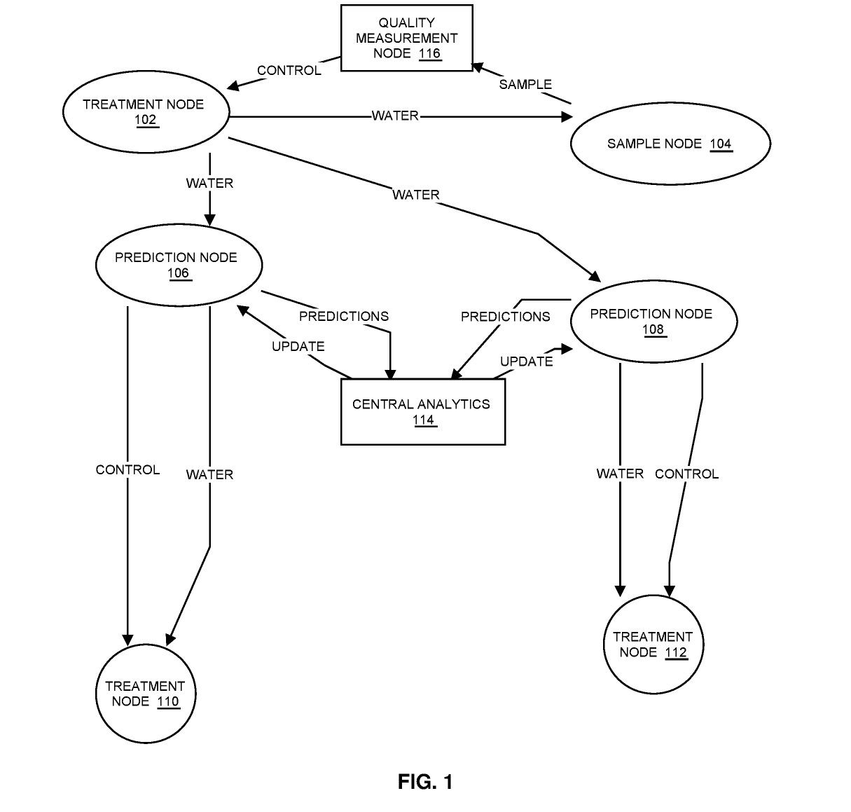

FIG. 1 is a system diagram of an embodiment of a water quality control system.

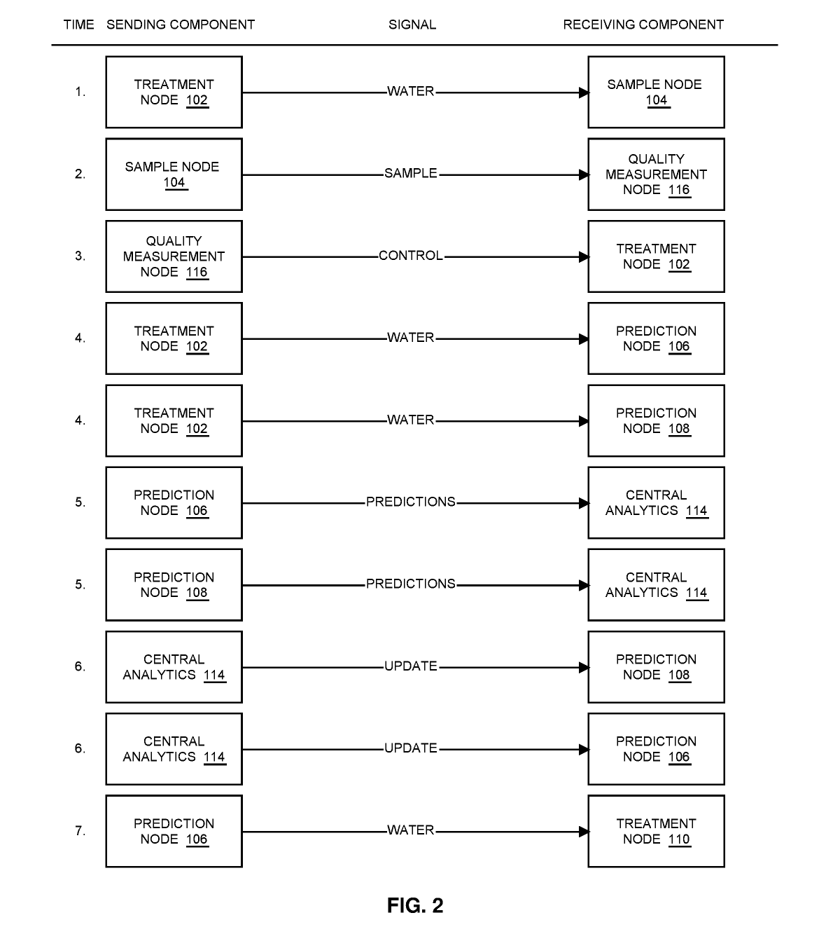

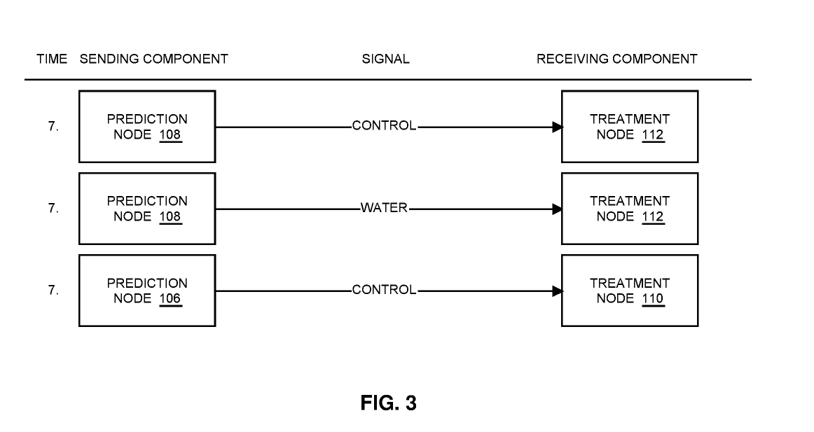

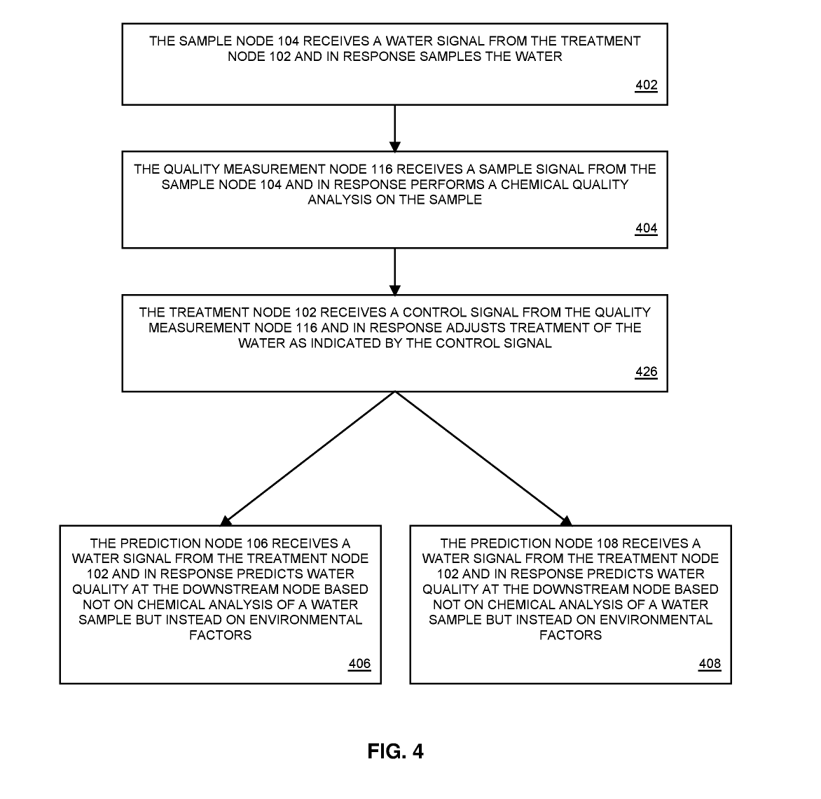

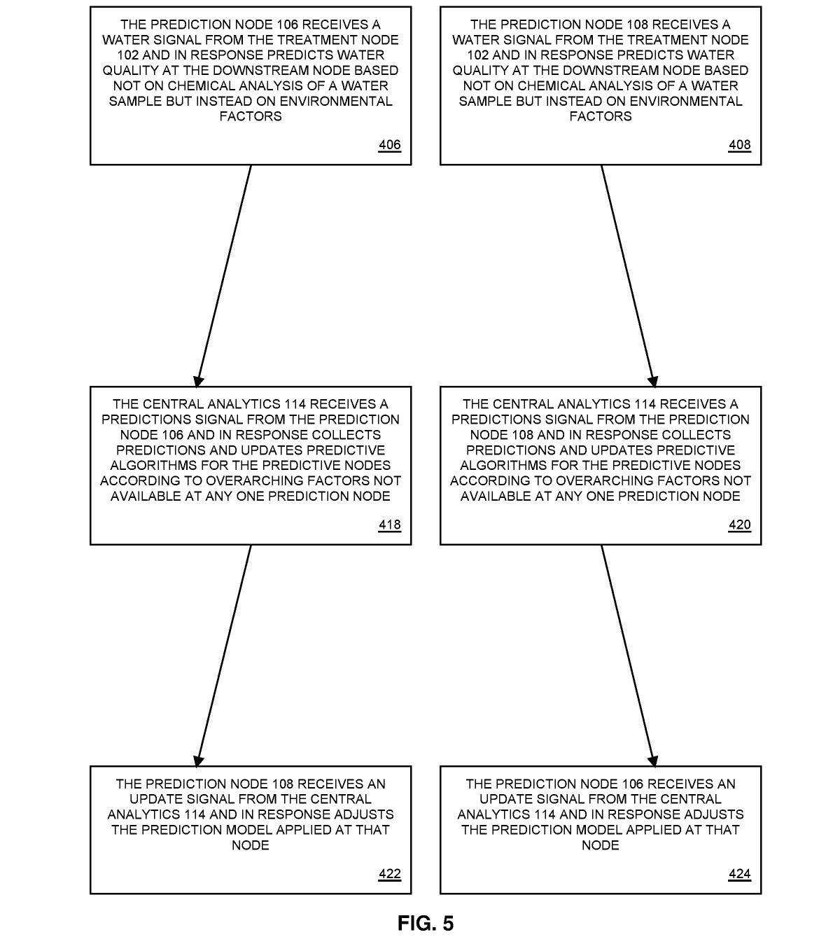

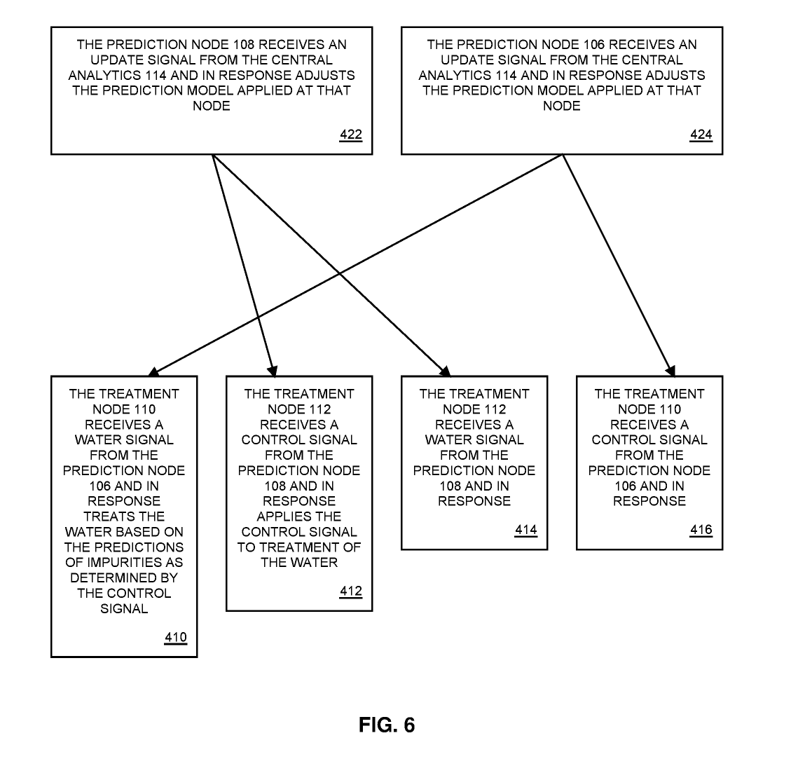

FIG. 2-3 is an action flow diagram of an embodiment of a water quality control process. FIG. 4-6 is a flow chart of an embodiment of a water quality control process.

The system comprises a treatment node 102, sample node 104, prediction node 106, prediction node 108, treatment node 110, treatment node 112, central analytics 114, and quality measurement node 116. The sample node 104 receives water from the treatment node 102 and in response samples the water (402). The quality measurement node 116 receives a water sample from the sample node 104 and in response performs a chemical quality analysis on the sample (404). Other types of quality analysis may be performed as well. “Chemical” quality analysis herein refers to analysis for chemical impurities in the water, as well as undissolved particulate impurities and biological impurities.

The quality measurement node 116 forms control signals to the treatment node 102 in response to results of the quality analysis on the water sample from the sample node 104. The control signal may direct the treatment node 102 to increase or decrease a rate of processing water for certain impurities. Thus the treatment node 102 receives the control signal from the quality measurement node 116 and in response adjusts treatment of the water as indicated by the control signal (426). The treatment node 102 may exist “upstream” in the water distribution system, performing large scale centralized water treatment on high volumes of water flowing at fast rates, for example at a municipal level. It may be enormously expensive to perform certain types of water treatment to achieve high purity levels at the very high flow rates extant at upstream locations such as municipal treatment centers. Embodiments of the present invention alleviate the high quality treatment constraints upstream nodes experiencing high flow rates on high volumes of water.

Downstream of the treatment node 102, a first prediction node 106 receives water from the treatment node 102 and in response predicts water quality at the downstream node based not on chemical quality analysis of the water, which is expensive, but instead based on environmental factors (406) local to the prediction node 106, which is physically closer in the water distribution system to where the water will be consumed. In addition to local environmental factors, the prediction node 106 may receive from the quality measurement node 116 information about impurity levels in the water exiting the treatment node 102. Likewise, to the prediction node 106, the prediction node 108 receives water from the treatment node 102 and in response predicts water quality based not on chemical quality analysis but instead on environmental factors (408) local to consumers of the water received at the prediction node 108.

In this manner, the treatment node 102 is alleviated of providing expensive one-size-fits-all water treatment to quality levels that may exceed what is required by particular downstream consumers. Furthermore, the prediction node 106 and prediction node 108 may comprise inexpensive machines that do not need to perform expensive water chemical quality analysis as is performed upstream by the quality measurement node 116.

The central analytics 114 receives water quality predictions from the prediction node 106 and prediction node 108 and in response collects predictions and updates predictive algorithms according to overarching factors not available at any one prediction node (418) (420). Each of the prediction node 108 and prediction node 106 receives a prediction algorithm update from the central analytics 114 and in response adjusts the prediction model applied at that node (422) (424).

The treatment node 110 receives water and a control signals from the prediction node 106 and in response treats the water based on the predictions of impurities as determined by the control signal (410) (416) from the prediction node 106. Likewise, the treatment node 112 receives water and a control signal from the prediction node 108 and in response applies the control signal to treatment of the water (412) (414). The downstream treatment node 110 and treatment node 112 may be much less expensive than the upstream treatment node 102 because they operate on lower volumes of water at lower consumption rates, and because they need only apply specific incremental quality improvements to the local water as demanded by the needs of their local consumers.

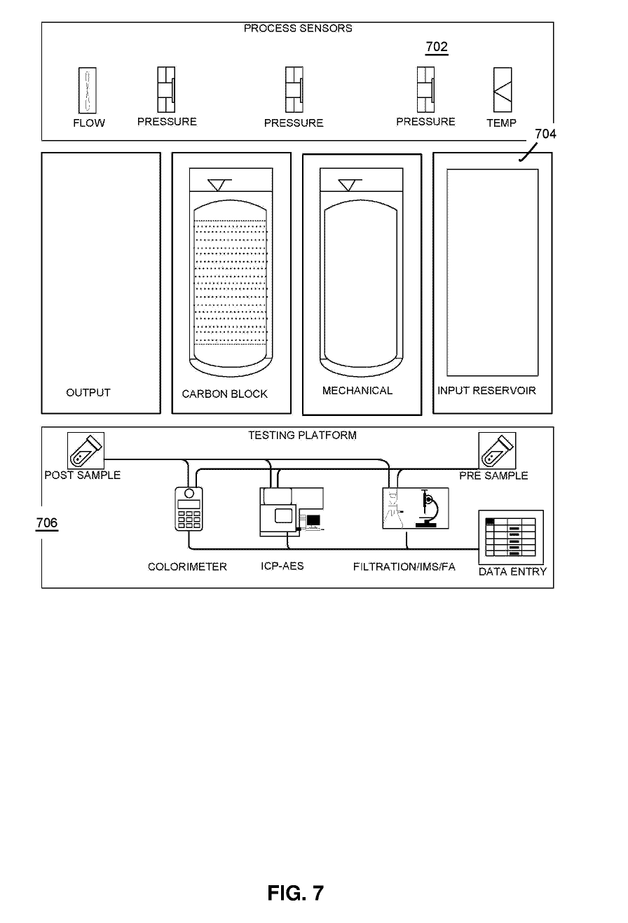

FIG. 7 illustrates example components of a prediction node (702), treatment node (704), and analysis node (706).

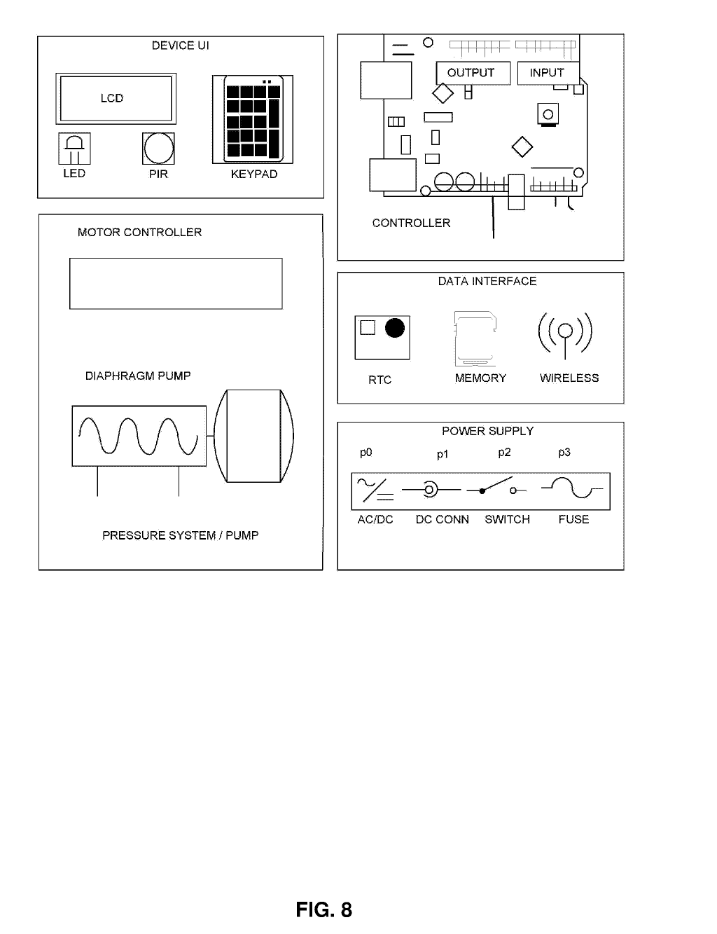

FIG. 8 illustrates additional example components of a prediction node.

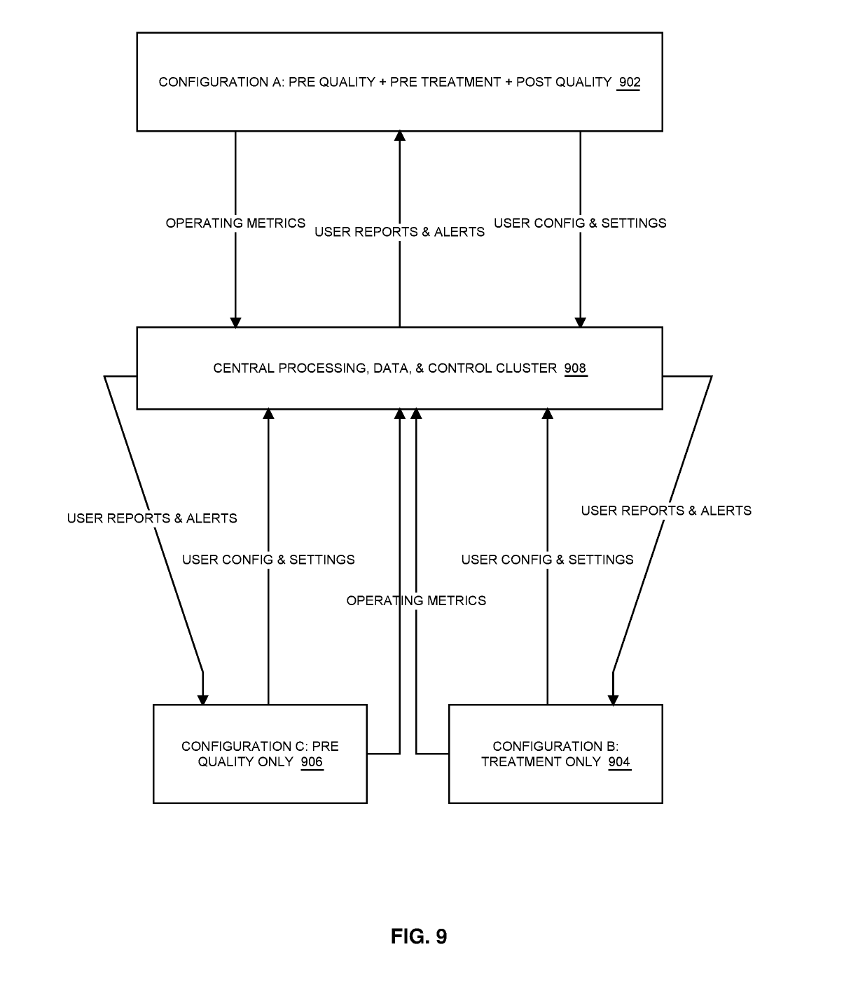

FIG. 9 illustrates signal transmission between the Central Processing, Data, & Control Cluster 908 and various configurations of the water quality control system.

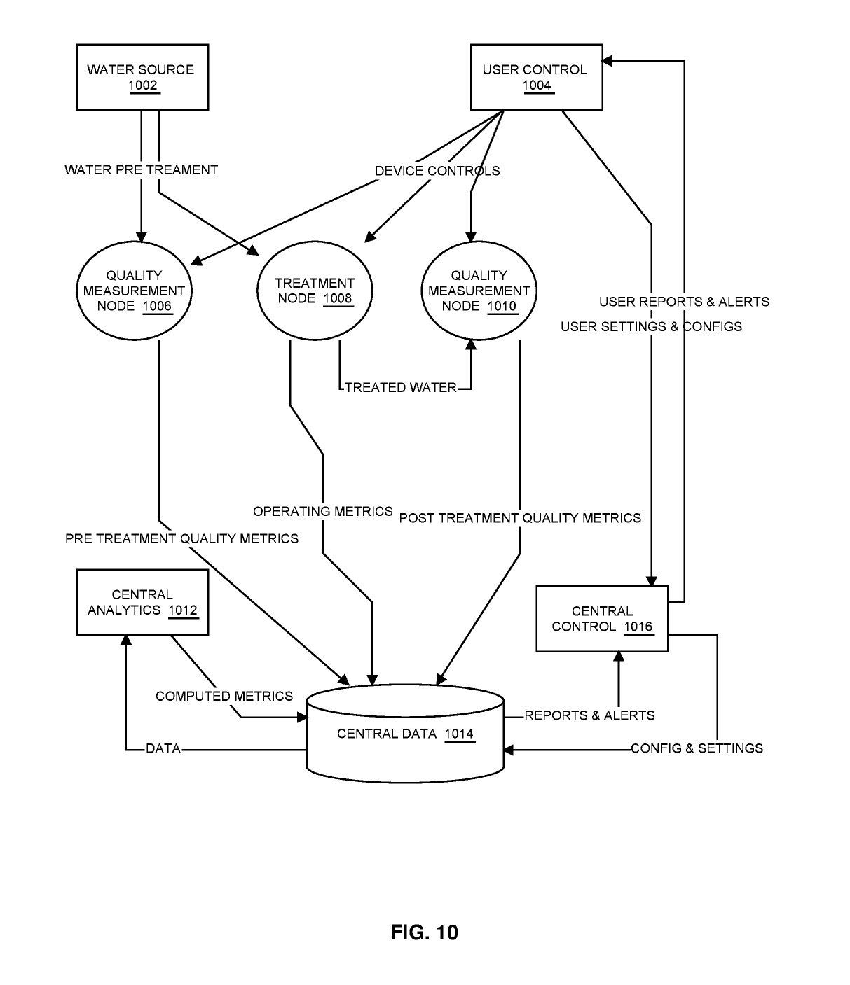

FIG. 10 is an embodiment of the water quality control system configured for pre quality, treatment, and post quality processes. The aforementioned embodiment utilizes a collection of components, herein referred to as Configuration A, comprising Water Source 1002, User Control 1004, Quality Measurement Node 1006, Treatment Node 1008, and Quality Measurement Node 1010. Configuration A interacts with a central processing, data, and control cluster comprising Central Analytics 1012, Central data 1014, and Central Control 1016. The Water Source 1002 provides Water (pre treatment) to the Quality Measurement Node 1006 and the Treatment Node 1008. The water (pre treatment) is water that has not undergone treatment by the current embodiment of the water quality control system. The Quality Measurement Node 1006 performs a pre treatment quality analysis on the water (pre treatment) received from the Water Source 1002. The pre treatment quality analysis performed by the Quality Measurement Node 1006 may be modified by device control signals received from User Control 1004. The Quality Measurement Node 1006 derives metrics and sends pre treatment quality metrics to Central Data 1014. The Treatment Node 1008 processes water (pre treatment) received from Water Source 1002 for impurities. Treatment Node 1008 receives device control signals from User control 1004 which may change the rate or process used to treat water (pre treatment). The Treatment Node 1008 sends operating metrics signal to Central Data 1014 which may be related to process and rate of the water treatment. Treated water is directed from the Treatment Node 1008 to the Quality Measurement Node 1010. Treated water received by the Quality Measurement Node 1010 undergoes a post treatment quality analysis. The post treatment quality analysis preformed on the treated water may be modified by device control signal from received from the User control 1004. The Quality Measurement Node 1010 derives metrics sends post treatment quality metrics to Central data 1014.

Central Control 1016 interacts with User Control 1004 to function as a user interface. User control 1004 sends User configurations and settings to Central data through central control 1016. Central control 1016 receives User configuration and setting signal from user control 1004 and sends Central data 1014 a Configuration and Settings Signal. Central data 1014 sends reports and alerts to User Control 1004 through Central Control 1016. Central Control 1016 receives reports and alerts signal from Central data 1014 and sends User Control 1004 User reports & alerts signal.

Central data 1014 functions as data storage and receives pre treatment quality metrics signal from Quality Measurement Node 1006, operating metrics signal from Treatment Node 1008, and Post treatment quality metrics signal from Quality measurement node 1010.

Central Analytics 1012 functions as the computational element that process data received by central data 1014. Central analytics 1012 receives data signals derived from pre treatment quality metrics, operating metrics, post treatment metrics, and Configuration and settings signals received by central data 1014. Central analytics 1012 utilizes the received data signal to compute metrics that are sent to the Central data 1014 as computed metrics signal. Computed metrics signal received by central data 1014 may be sent as reports and alerts signal to Central Control 1016.

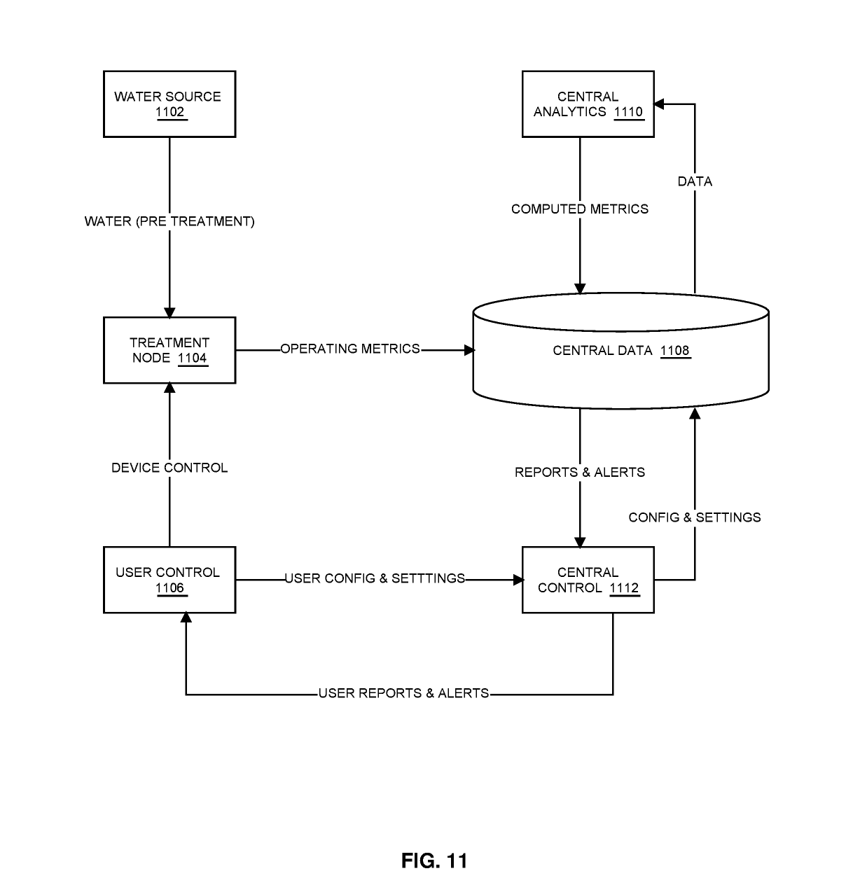

FIG. 11 is an embodiment of the water quality control system configured for treatment only process.

Configuration B utilizes a collection of components comprising Water Source 1102, Treatment Node 1104, and User Control 1106. Configuration B interacts with a central processing, data, and control cluster comprising Central Analytics 1110, Central Data 1108, and Central Control 1112. The Water Source 1102 provides Water (pre treatment) to the Treatment Node 1104. Water (pre treatment) is water that has not undergone treatment by the current embodiment of the water quality control system. The Treatment Node 1104 processes Water (pre treatment) received from the Water Source 1102 for impurities. Treatment Node 1104 receives device control signals from User Control 1106 which may change the rate or process used to treat Water (pre treatment). Treatment Node 1104 sends operating metrics signal to Central Data 1108 which may be related to process and/or rate of the water treatment.

Central Control 1112 interacts with User Control 1106 to function as a user interface. User control 1106 sends User configurations and settings to Central data 1108 through central control 1112. Central control 1112 receives User configuration and setting signal from user control 1106 and sends Central data 1108 a Configuration and Settings Signal. Central Data 1108 sends reports and alerts to User control 1106 through central control 1112. Central control 1112 receives reports and alerts signal from central data 1108 and sends user control 1106 user reports and alerts signal.

Central Data 1108 functions as data storage and receives operating metrics signal from Treatment Node 1104, computed metrics signal from Central Analytics 1110, and configuration and settings signal from Central Control 1112.

Central Analytics 1110 functions as the computational element that processes data received by Central Data 1108. Central Analytics 1110 receives data signals derived from operating metrics and d user configurations and settings. Central Analytics 1110 utilizes the received data signal to computed metrics that are sent to Central Data 1108 as computed metrics signal. Computed metrics signal received by Central Data 1108 may be sent as reports and alerts signal to Central Control 1112.

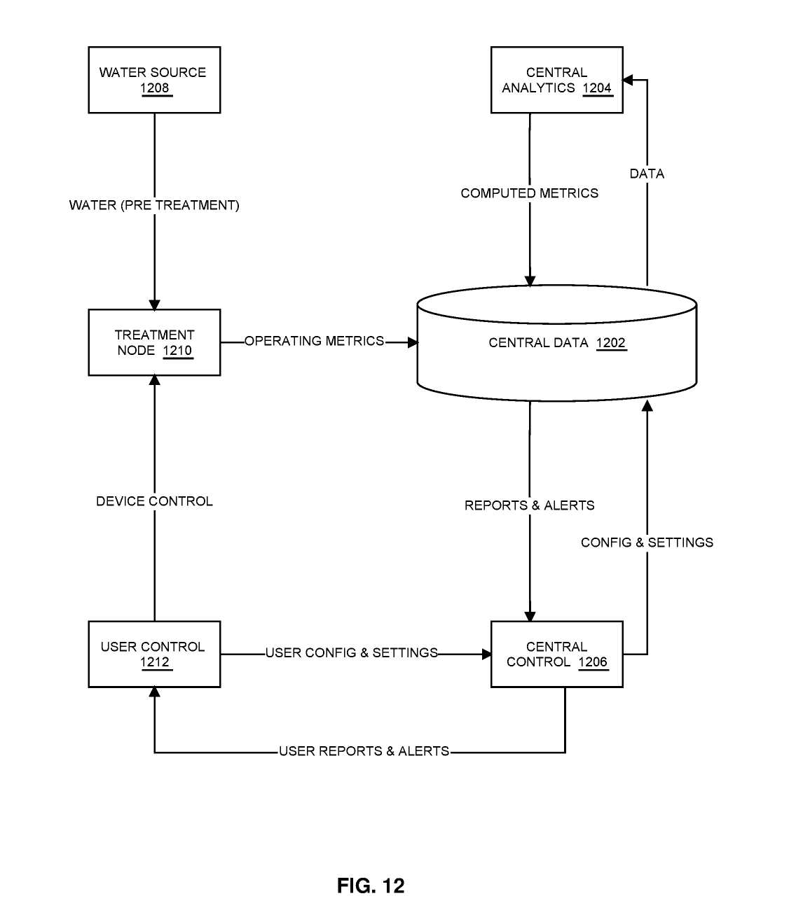

FIG. 12 shows one exemplary embodiment of the water quality control system configured for pre quality only process.

Configuration C utilizes a collection of components comprising Water Source 1208, Treatment Node 1210, and User Control 1212. Configuration C interacts with a central processing, data, and control cluster comprising Central Analytics 1204, Central Data 1202, and Central Control 1206. The Water Source 1208 provides Water (pre treatment) to the Treatment Node 1210. Water (pre treatment) is water that has not undergone treatment by the current embodiment of the water quality control system. The Treatment Node 1210 processes Water (pre treatment) received from the Water Source 1208 for impurities. Treatment Node 1210 receives device control signals from User Central Control 1206 which may change the rate or process used to treat Water (pre treatment). Treatment Node 1210 sends operating metrics signal to Central Data 1202 which may be related to process and/or rate of the water treatment.

Central Control 1206 interacts with User Control 1212 to function as a user interface. User Control 1212 sends User configurations and settings to Central Data 1202 through Central Control 1206. Central Control 1206 receives User configuration and setting signal from User Control 1212 and sends Central Data 1202 a Configuration and Settings Signal. Central Data 1202 sends reports and alerts to User Control 1212 through Central Control 1206. Central Control 1206 receives reports and alerts signal from Central Data 1202 and sends User Control 1212 user reports and alerts signal.

Central Data 1202 functions as data storage and receives operating metrics signal from Treatment Node 1210, computed metrics signal from Central Analytics 1204, and configuration and settings signal from Central Control 1206.

Central Analytics 1204 functions as the computational element that processes data received by Central Data 1202. Central Analytics 1204 receives data signals derived from operating metrics and d user configurations and settings. Central Analytics 1204 utilizes the received data signal to computed metrics that are sent to Central Data 1202 as computed metrics signal. Computed metrics signal received by Central Data 1202 may be sent as reports and alerts signal to Central Control 1206.

What is claimed is:

1. A method of predicting water quality comprising:
A first water source;
Characterizing the first water source with a first quality metric to provide a first measurement;
Treating the first water source with a first water treatment system to provide a first treated water supply;
Characterizing the first treated water supply with the first quality metric to provide a second measurement;
Determining differences, according to the first quality metric, between the first measurement and the second measurement;
Determining an operating metric for the water treatment system corresponding to the said differences.

2. The method of claim 1, wherein the first quality metric is chosen from pH, turbidity, microbes, radioactivity, nano particles, or chemical concentration.

3. The method of claim 2, wherein the first quality metric is chemical concentration.

4. The method of claim 3, wherein the chemical is an oxidizing agent.

5. The method of claim 3, wherein the chemical is a metal.

6. The method of claim 1, wherein the operating metric is chosen from temperature, flow rate, pressure, time of usage, configuration of components, or volume of usage.

7. The method of claim 1, wherein the water treatment system is a filter.

8. The method of claim 7, wherein the water treatment system is a carbon filter.

9. The method of claim 6, wherein the operating metric is flow rate.

10. The method of claim 1, comprising:
a second water source; and
characterizing the second water source with the first quality metric.

11. The method of claim 10, comprising treating the second water source to provide a second treated water supply;
characterizing the second treated water supply a plurality of times with the first quality metric to provide a plurality of measurements for the first quality metric; and
collecting the said plurality of measurements in a data storage means, said data storage means equipped with a user interface capable of providing a physical representation of the measurements.

12. The method of claim 11, comprising a third water source; and
determining a value for the first quality metric for the third water source based on the plurality of measurements and the operating metric.

13. A system for predicting water quality comprising:
A means for determining how a water treatment system affects a first water quality measurement for a first water source under a set of operating parameters;
A means for determining a second water quality measurement for a second water source at a time before processing by the said water treatment system;
A physical representation of the expected value of the first water quality measurement for the said second water source after processing by said water treatment system.

14. The system of claim 13, additionally comprising:
An optimization engine for refining one or more operating parameters for processing the second water source with the water treatment system.

15. The method of claim 14, wherein the one or more operating parameters comprise flow rate.
